(19) United States
(12) Patent Application Publication
(10) Pub. No.: US 2014/0292636 A1
(43) Pub. Date: Oct. 2, 2014

(54) Head-Worn Infrared-Based Mobile User-Interface

(71) Applicant: PLANTRONICS, INC., Santa Cruz, CA (US)

(72) Inventor: Douglas K. Rosener, Santa Cruz, CA (US)

(73) Assignee: Plantronics, Inc., Santa Cruz, CA (US)

(21) Appl. No.: 13/853,852

(22) Filed: Mar. 29, 2013

(51) Int. Cl. G06F 3/03; H04N 5/33

(52) U.S. Cl. CPC G06F 3/0304; H04N 5/33
USPC 345/156

(57) ABSTRACT

Methods and apparatuses for device user interfaces are disclosed. In one example, a head-worn apparatus includes a processor, a wireless communications transceiver, and an infrared camera configured to detect an infrared light associated with a movement of a user hand and provide an infrared camera output. The head-worn apparatus includes a sensor unit configured to detect motion of a user head and provide a sensor unit output. The head-worn apparatus further includes a memory storing an application configured to receive the infrared camera output and the sensor unit output to identify a user action from the movement of the user hand.

### BACKGROUND OF THE INVENTION

In certain situations, a user may obtain information from passive objects. For example, a printed map may show the user where they currently are and where they can go. Such maps are found at shopping malls, transportation terminals, or certain areas in a city. However, the user may want to know more about various points on the map, how long it will take to get to a destination from the present location, and directions to the desired location. The passive map is unable to provide any information in addition to what is already displayed. In a further scenario, a user may wish to interact with a surface which has a computer-projected image displayed on the surface.

As a result, improved methods and apparatuses for user interfaces are needed.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a system for an infrared based mobile user interface in one example.

FIG. 2 illustrates a simplified block diagram of the head-worn device shown in FIG. 1.

FIG. 3 illustrates a simplified block diagram of the electronic device shown in FIG. 1.

FIG. 4 illustrates an example implementation of the system shown in FIG. 1 whereby a user creates a virtual coordinate system using a four point touch calibration.

FIG. 5 illustrates an example implementation of the system shown in FIG. 1.

FIG. 6 illustrates an example implementation of the system shown in FIG. 4 and FIG. 5.

FIG. 7 is flow diagram illustrating operation of an infrared based mobile user interface.

FIG. 8 illustrates a head-worn device image coordinate system.

FIG. 9 illustrates a map coordinate system.

### DESCRIPTION OF SPECIFIC EMBODIMENTS

Methods and apparatuses for user interfaces are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

The inventor has recognized that if a user can superimpose an electronic user interface onto a passive sign or surface, the user can make queries to a computer based application that can provide information or data in addition to that provided by the passive sign or surface. In other words, the inventor has recognized that by superimposing an electronic user interface onto a passive surface, the surface can become interactive.

In one example, a head-worn apparatus includes a processor, a wireless communications transceiver, and an infrared camera configured to detect an infrared light associated with a movement of a user hand and provide an infrared camera output. The head-worn apparatus includes a sensor unit configured to detect motion of a user head and provide a sensor unit output. The head-worn apparatus further includes a memory storing an application configured to receive the infrared camera output and the sensor unit output to identify a user action from the movement of the user hand.

In one example, one or more non-transitory computer-readable storage media have computer-executable instructions stored thereon which, when executed by one or more computers, cause the one more computers to perform operations including receiving an infrared camera output from an infrared camera disposed at a head-worn apparatus, monitoring a movement of an infrared light source associated with a user hand from the infrared camera output, and identifying a user action at an object remote from the head-worn apparatus from the movement of the infrared light source.

In one example, a system includes one or more computers, and one or more non-transitory computer-readable storage media have computer-executable instructions stored thereon which, when executed by the one or more computers, cause the one or more computers to perform certain operations. The operations include receiving an infrared camera output from an infrared camera disposed at a head-worn apparatus, monitoring a movement of an infrared light source associated with a user hand from the infrared camera output, and identifying a user action at an object remote from the head-worn apparatus from the movement of the infrared light source.

One embodiment of the invention attaches an infrared (IR) blob-tracking camera into a headset. For example, the Nintendo Wii Remote IR camera is capable of tracking up to four independently-moving regions of brightness (referred to as “blobs”) on a 1024×768 resolution frame at 100 frames/second. By placing a similar IR camera in the headset, the described user interface herein is mobile and can therefore be used anywhere without the need to set up a fixed IR camera at a particular location. The camera output is attached to a processor in the headset. For example, the processor may be a CSR 8670 Bluetooth system on a chip, or this chip in combination with a coprocessor for doing image analysis. The camera output is processed and either used on the headset directly or passed on to a host (e.g., a mobile smartphone).

Unlike a fixed camera, as the head moves, the image will move as well. It is necessary to distinguish image movement due to the fingers from image movement due to the head. The headset is equipped with sensors (e.g., inertial sensors like single-axis or multi-axis gyroscope, single axis or multi-axis accelerometers, and multi-axis magnetometers), to compensate for the motion of the head and eliminate the head motion from the blob movement calculation.

There are two possible IR source embodiments. The headset could be equipped with an IR source that illuminates reflective material placed on the fingers (e.g., thimbles or gloves). Alternatively, the fingers could be equipped with battery powered IR sources.

One application of the invention is to turn a third-party passive sign into an active one. In this application, the system includes a third-party server with a uniform resource locator (URL), a mobile phone with internet access and associated user interface application, and a user wearing the head-worn device. First, the user contacts the server through the mobile application. This could be done by the user tracing a URL with the fingers on the surface and the blob-tracking mechanism could use this to identify the desired URL and connect. This could also be done by a voice command on the headset, scanning a quick response (QR) code on the sign (suitably reflective in IR frequencies) with the headset camera and decoding into the URL. This could also be done using an NFC exchange between headset (reader) and sign (passive NFC tag) on the headset or users mobile phone, scanning with the mobile phone camera or at a minimum manually entering the URL displayed on the sign into the user's mobile device.

With this application, the user could walk to the map, contact the associated URL, and then touch the four corners of the map, identifying the reference points for future touches. Then they could place the fingers on points of interest. The finger location could be sent to the server at the associated URL which could respond with useful information about the map as audio in the ear of the user via the headset. Advantageously, (for those cases where the mobile phone is not needed to obtain the URL directly) the user need not retrieve their mobile phone from their pocket or purse.

In another application, the user can interact with a passive surface on which an infrared or video image has been projected by a computer. The image can correspond to a computer application, where the user actions at the passive surface are used to control the application in a manner similar to a touch user interface. Advantageously, the described systems and methods allow any passive sign or surface to become an interactive user interface and inform the user about items on the surface, as well as serve as controls. In further applications, the described systems and methods can be used to capture hand gestures, or draw pictures or Chinese characters on a surface or in the air.

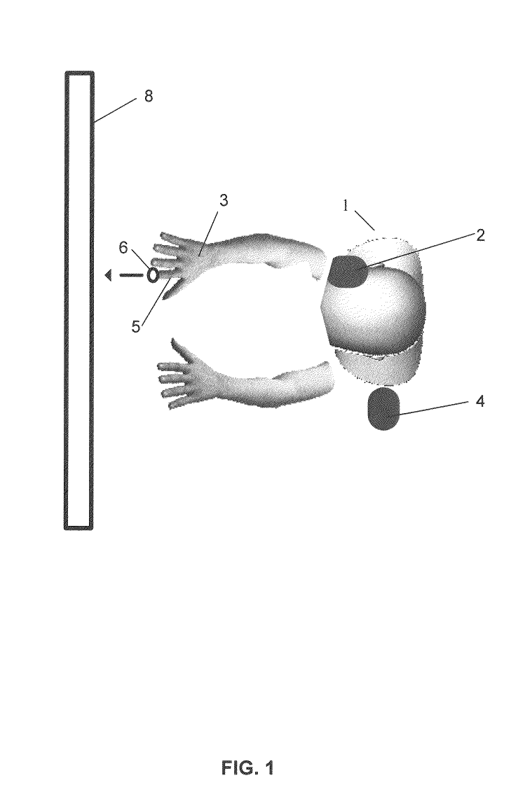

FIG. 1 illustrates a system for an infrared based mobile user interface in one example. A head-worn device 2 includes an infrared camera configured to detect an infrared light associated with a movement of a user hand 3. The head-worn device 2 includes a sensor unit configured to detect motion of a user 1 head. The head-worn device 2 identifies a user action at an object 8 from the movement of the user hand 3. For example, the object 8 may be a planar surface with which the user 1 desires to interact. Movement of the user hand 3 is detected by the infrared camera via an infrared (IR) light source 6 associated with the user hand 3. In one example, the head-worn device 2 includes a microphone and a speaker, where responsive to the user action the head-worn device 2 provides an audio output at the speaker. As described in further detail below, the user action may be a user selection of a coordinate location on a coordinate system defined by the user and virtually overlaid on a surface of object 8.

In one implementation, the IR light source 6 is an infrared light reflected from an IR reflective material worn on a finger of the user hand 3. In this implementation, the head-worn device 2 includes an infrared light emitting device emitting IR light which is reflected from the reflective material and detected by the infrared camera. In a further implementation, the IR light source 6 is an infrared light emitting device (e.g., a light emitting diode) worn on a finger of the user hand 3. In yet another example, IR light source 6 may be a light emitting device held by the user hand 3, such as a device having a pen form factor.

In one example, the head-worn device 2 and the electronic device 4 each include a two-way RF communication device having data communication capabilities. The head-worn device 2 and electronic device 4 are capable of wireless communications there between and may have the capability to communicate with other computer systems via a local or wide area network. In a further example, wired links between devices may be used.

Head-worn device 2 and electronic device 4 are operable together to receive an infrared camera output from an infrared camera disposed at a head-worn device 2, monitor a movement of an infrared light source 6 associated with a user hand 3 from the infrared camera output, and identify a user action at an object 8 remote from the head-worn device 2 from the movement of the infrared light source 6. For example, electronic device 4 is a device capable of connecting to a communications network such as a cellular communications network or the Internet. In certain examples, electronic device 4 is a mobile wireless device such as a smartphone, tablet computer, or a notebook computer. In further examples, electronic device 4 may be a desktop PC.

In one example, head-worn device 2 is operable to receive a sensor unit output from a sensor unit configured to detect motion of a user head and/or the user. The head-worn devices processes the sensor unit output as part of monitoring the movement of an infrared light source associated with a user hand.

In one example, the user action at an object 8 remote from the head-worn device 2 is a user input selection at a planar surface. In one example, the head-worn device initiates an operation at a computer (e.g., electronic device 4) responsive to the user action or initiates an operation at the head-worn device 2 responsive to the user action.

In one example, the object 8 is a planar surface and the user action is to define a virtual coordinate system on the planar surface. For example, the user may touch four points on the planar surface to define a rectangle. The user action identified by the head-worn device 2 may be a user selection of a coordinate location within the virtual coordinate system.

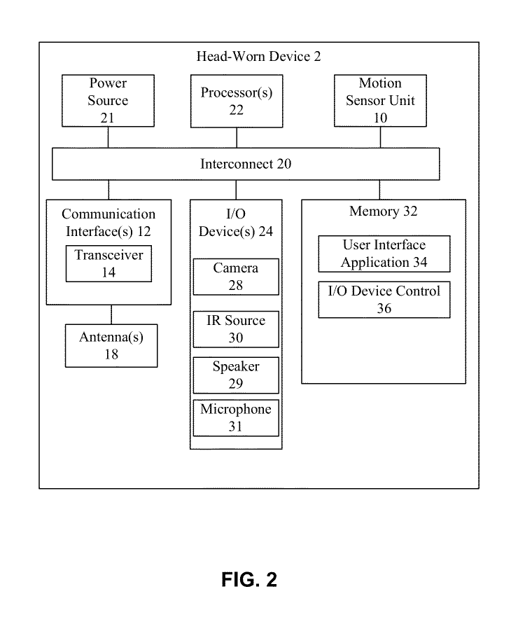

FIG. 2 illustrates a simplified block diagram of the head-worn device 2 shown in FIG. 1. Head-worn device 2 may, for example, be a telecommunications headset, headphones, or eye glasses. Head-worn device 2 includes input/output (I/O) device(s) 24, including an IR camera 28, speaker 29, and microphone 31. For example, IR camera 28 is a 2-D IR camera. IR Camera 28 is configured to output camera data. I/O device(s) 24 may also include additional input devices and output devices. Camera 28 is disposed at head-worn device 2 so that it detects infrared light sources in front of a user wearing head-worn device 2. In the example shown in FIG. 2, head-worn device 2 includes an IR source 30. In a further example, the IR source is external to head-worn device 2. For example, the IR source may be disposed at an external device or on the user finger itself. In further example, the number of IR light sources and IR cameras may also be varied. A power source 21 such as a rechargeable battery provides the necessary power to the components of the head-worn device 2.

Head-worn device 2 includes a motion sensor unit 10 operable to detect motion in one more directions. For example, motion sensor unit 10 includes one or more sensors, including magnetometers, accelerometers, and gyroscopes, which can be used determine orientation. Motion sensor unit 10 includes an image stabilization unit to compensate for movement of the user head. The orientation sensors may utilize an electronic compass (magnetometer) supported by an accelerometer for eliminating tilt and rotation sensitivity, or a gyroscope, or all three in a sensor fusion system to detect a viewing direction of user 1 and motion of the user 1 head.

In one example, an image stabilization process includes 2-D image stabilization to correct for motion of the user. 2-D image stabilization uses the known orientation of the device taking the image and corrects the image change due to changes in device (in this case headset camera 28) orientation. For example, if the head-worn device 2 tilts downward, the image of the finger (i.e., IR source 6) will appear to move upward. If the angle change of the head is known, this can be used to compute the change in coordinates of the finger image for a fixed finger-head distance. For example a head tilt downward will raise the finger image a distance in the y direction

Δy≈Dθ

where D is the distance from center of head rotation to finger and θ is the angle of the head tilt. This effective change can subtracted from the image coordinates of the fingers. If the finger is fixed in location, this keeps the relative finger location with respect to the calibration mapping constant for small changes in the head orientation. This results in the finger pointing to the same location on the object 8 (e.g., a printed map). In general, if the object 8 is small enough to be in the user's field of view, the user will touch the object 8 keeping their location and finger distance constant, requiring only 2-D image stabilization.

In one example, an image stabilization process includes 3-D image stabilization to account for movement of the user 1 closer or farther away from the object 8 or movement from left or right along the object 8. 3-D image stabilization takes into account the changes in location from the user 1 to the object 8. For example, if the user 1 moves closer to the object 8, effective button coordinates will increase in angle from the center of the object 8 (assuming the user 1 is looking at the center of object 8). If the change in distance is known, the effective change can be calculated and again the effective coordinates of the fingers can be kept constant. Similarly, translations left and right, translate the finger coordinates. If the user location is known, these can also be offset from the finger coordinates to stabilize them.

In one example, head tracking events (e.g. sensor output from sensor unit 10) contain the current angles for the head-worn device 2. These can be converted into a heading, either absolute (e.g., 30° NE) or relative to some calibration. They can also be converted into an elevation (e.g., 30 degrees up or down) if the sensors provide the additional tilt information. Using a calibration process, sensor output from sensor unit 10 is utilized to compensate for undesirable motion of the user 1 to accurately determine movement of the user hand using IR camera 28. For example, the user may select an initial fixed start position of the head-worn device 2 such that all further movements with respect to this fixed start position are compensated for (i.e., eliminated) in determining the position of the IR light source 6.

IR camera 28 operates to capture an image viewed from the head-worn device 2 as described below. In particular, IR camera 28 captures an image of IR light source 6 when it is in view of IR camera 28. The user interface application 34 uses images output from the IR camera 28 to identify user interface actions. For example, the captured images output are processed to identify the presence or absence of object images corresponding to IR light source 6, and movement of object images corresponding to IR light source 6.

IR camera 28 is integrated with the head-worn device 2 housing, which includes an aperture on a front surface allowing IR light to be received by the IR camera 28. The IR camera 28 is positioned to capture a wide angle view a direction forward to the user sight line when the head-worn device 2 is worn by the user. An image processor analyzes image data captured by IR camera 28 to determine the presence of high luminance areas in the image. The location and size of any high luminance areas within the 2-D grid of the IR camera 28 is also determined.

IR camera 28 may include a lens, IR filter, an image capturing device, and an image processor. In one example, the image capturing device is a charged coupled device (CCD) or CMOS censor. IR light source 6 associated with the user finger (either directly or via a reflection) outputs IR light toward the front of the camera 28. If the IR camera 28, and therefore the head-worn device 2, is directed towards the user hand, the IR light passes through the lens and IR filter to impinge upon the image capturing device to create an object image. The image processor calculates the positions of objects (i.e., IR light source 6) whose images are to be captured in the captured image. The image processor outputs captured image data including coordinate values indicating the positions of the IR light source 6 object image in the captured image to the processor 22. The captured image data output is transmitted to user interface application 34 which utilizes the captured image data to identify a user interface action as described herein.

IR light source 6 emits IR light within a visual field angle range, herein after referred to as the IR light source visual field angle range. The IR camera 28 can receive light within a certain visual field angle range, herein after referred to as the camera visual field angle range. When the head-worn device 2 is directed at the user hand such that IR light source 6 is present within the camera visual field angle range, the head-worn device 2 can detect IR light source 6. The IR camera 28 captures an image of IR light source 6. When the user hand is not in the camera visual field angle range, the head-worn device 2 cannot detect IR light source 6.

In one usage scenario, user 1 faces a desired object 8 with which he wishes to interact and perform user interface actions. The user viewing direction is detected by processing orientation data output by orientation sensors at head-worn device 2. In one example, the data is sent to and processed by electronic device 4. Any change in viewing direction is subsequently compensated for in determining the desired user interface action.

The head-worn device 2 includes a processor 22 configured to execute code stored in a memory 32. Processor 22 executes a user interface application 34 and an I/O device control application 36 to perform functions described herein. Although shown as separate applications, user interface application 34 and I/O device control application 36 may be integrated into a single application.

Utilizing user interface application 34, head-worn device 2 is operable to process the camera data from camera 28 to identify a desired user interface action from movement of a user hand (e.g., one or more user fingers). Following this identification, head-worn device 2 may transmit the desired user interface action to electronic device 4 for responsive action by an application program. The identified user interface action may be utilized by an application program being executed on head-worn device 2, electronic device 4, or a device in communication with either head-worn device 2 or electronic device 4. User interface application 34 is operable to process data received from motion sensor unit 10 to stabilize the image data output from camera 28 in order to increase the accuracy of determining the desired user interface action. For example, the user may perform a “select” action by performing a circle motion with his finger at the location on object 8 he wishes to select, performing an “x” motion with his finger at the desired location, or by lingering/hovering his finger at the desired location for a pre-determined amount of time to trigger a select input action.

While only a single processor 22 is shown, head-worn device 2 may include multiple processors and/or co-processors, or one or more processors having multiple cores. The processor 22 and memory 32 may be provided on a single application-specific integrated circuit, or the processor 22 and the memory 32 may be provided in separate integrated circuits or other circuits configured to provide functionality for executing program instructions and storing program instructions and other data, respectively. Memory 32 also may be used to store temporary variables or other intermediate information during execution of instructions by processor 22.

Memory 32 may include both volatile and non-volatile memory such as random access memory (RAM) and read-only memory (ROM). Data for head-worn device 2 may be stored in memory 32, including data utilized by user interface application 34. For example, this data may include data output from camera 28 and data output from motion sensor unit 10.

Head-worn device 2 includes communication interface(s) 12, one or more of which may utilize antenna(s) 18. The communications interface(s) 12 may also include other processing means, such as a digital signal processor and local oscillators. Communication interface(s) 12 include a transceiver 14. In one example, communications interface(s) 12 include one or more short-range wireless communications subsystems which provide communication between head-worn device 2 and different systems or devices. For example, transceiver 14 may be a short-range wireless communication subsystem operable to communicate with electronic device 4 using a personal area network or local area network. The short-range communications subsystem may include an infrared device and associated circuit components for short-range communication, a near field communications (NFC) subsystem, a Bluetooth subsystem including a transceiver, or an IEEE 802.11 (WiFi) subsystem in various non-limiting examples.

In one example, communication interface(s) 12 include a long range wireless communications subsystem, such as a cellular communications subsystem. The long range wireless communications subsystem may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol. In one example, head-worn device 2 includes a wired communications connection.

Interconnect 20 may communicate information between the various components of head-worn device 2. Instructions may be provided to memory 32 from a storage device, such as a magnetic device, read-only memory, via a remote connection (e.g., over a network via communication interface(s) 12) that may be either wireless or wired providing access to one or more electronically accessible media. In alternative examples, hard-wired circuitry may be used in place of or in combination with software instructions, and execution of sequences of instructions is not limited to any specific combination of hardware circuitry and software instructions.

Head-worn device 2 may include operating system code and specific applications code, which may be stored in non-volatile memory. For example the code may include drivers for the head-worn device 2 and code for managing the drivers and a protocol stack for communicating with the communications interface(s) 12 which may include a receiver and a transmitter and is connected to antenna(s) 18.

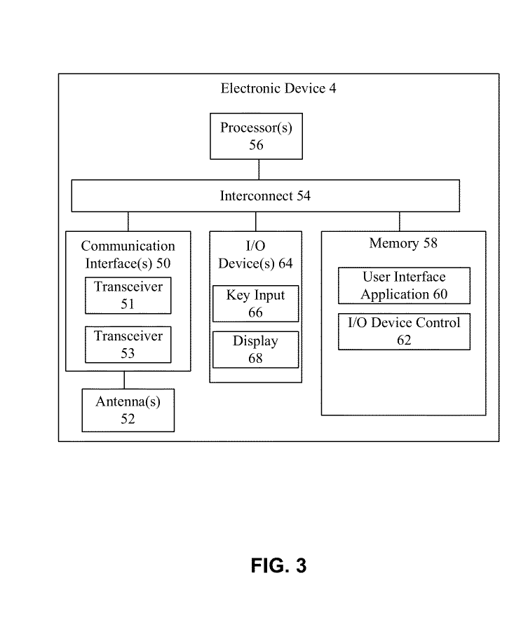

FIG. 3 illustrates a simplified block diagram of the electronic device 4 shown in FIG. 1. Electronic device 4 includes input/output (I/O) device(s) 64 configured to interface with the user, including a key input 66 and a display 68. I/O device(s) 64 may also include additional input devices, such as a touch screen, etc., and additional output devices. Display 68 may, for example, be a liquid crystal display (LCD).

The electronic device 4 includes a processor 56 configured to execute code stored in a memory 58. Processor 56 executes a user interface application 60 and an I/O device control application 62 to perform functions described herein. Although shown as separate applications, user interface application 60 and I/O device control application 62 may be integrated into a single application. In one example, the operations performed by user interface application 34 described above are performed by user interface application 60 at electronic device 4 instead. In a further example, performance of these operations can be divided between user interface application 34 and user interface application 60. In a further example, functions of electronic device 4 are performed by head-worn device 2.

Electronic device 4 includes communication interface(s) 50, one or more of which may utilize antenna(s) 52. The communications interface(s) 50 may also include other processing means, such as a digital signal processor and local oscillators. Communication interface(s) 50 include a transceiver 51 and a transceiver 53. Interconnect 54 may communicate information between the various components of electronic device 4. Transceiver 51 may be a short-range communications unit and transceiver 53 may be a long-range communications unit, similar to described above in reference to head-worn device 2. The block diagrams shown for head-worn device 2 and electronic device 4 do not necessarily show how the different component blocks are physically arranged on head-worn device 2 or electronic device 4.

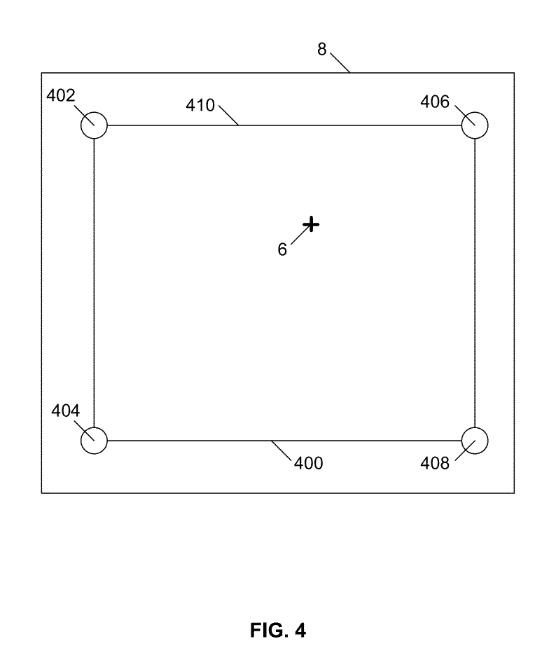

FIG. 4 illustrates an example implementation of the system shown in FIG. 1 whereby a user creates a virtual coordinate system using a four point touch calibration. In the example shown in FIG. 4, object 8 is a planar surface having an image 400 with which the user wishes to interface. In one example, image 400 may be a printed map. In a further example, image 400 may be an image projected from a projector onto object 8, where the projector is connected to a computing device. In operation the user performs a four point touch calibration by touching the four corners of image 400 at touch point 402, touch point 404, touch point 406, and touch point 408. The four point touch calibration establishes an x-y coordinate system frame 410 calibrated to the image 400.

By detecting the position of object images (i.e., x-y coordinates) corresponding to the IR light source 6 in the captured images, the location of a desired user action on image 400 is determined. The IR camera 28 image processor processes the image data of the captured IR images to detect coordinates within the frame 410 indicating a position of the object images corresponding to the IR light source 6. The detected coordinates may use an X-Y coordinate system where the width of the frame 410 is designated to be an X-axis and the height of the frame 410 is designated to be a Y-axis. In the image data, an IR light source object image appears as a high luminance area. Thus, the image processor detects an IR light object image when an area within the captured image has a luminance higher than a predetermined luminance value, and the area of the high luminance area has a size within a predetermined size range. Where the size of the high luminance area falls outside the predetermined size range, the image processor does not recognize the high luminance area as an IR light source object image. The coordinate data of each object image detected is utilized as described herein.

One of ordinary skill in the art will recognize that although the detection of the object images is described as being performed by the image processor at either the head-worn device 2 or the electronic device 4, captured images may be transferred to other computing devices where processing is performed. The camera sampling rate and pixel resolution of the IR camera 28 is selected to be sufficiently high so that the detections of the multiple IR light sources can be tracked (e.g., one IR light source on each user hand, or IR light sources on multiple fingers) and not confused with each other.

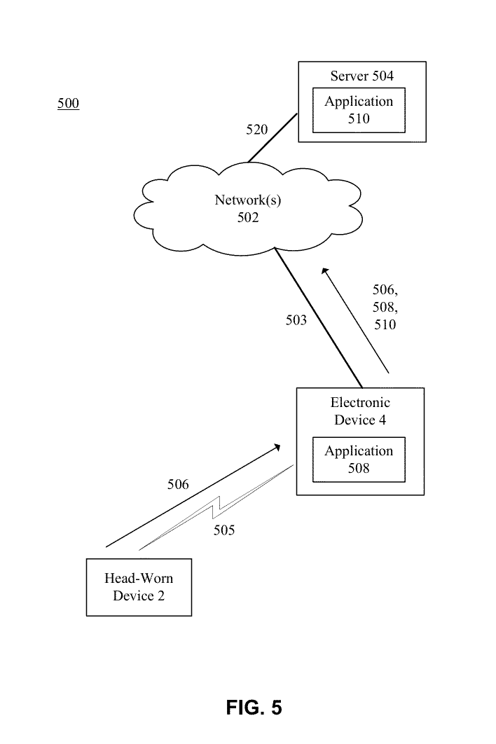

FIG. 5 illustrates an example implementation 500 of the system shown in FIG. 1. FIG. 5 illustrates the flow of user interface action data, such as user selected coordinates, in one example. Referring to FIG. 1 and FIG. 5, in implementation 500, electronic device 4 is capable of communications with one or more communication network(s) 502 over network connection 503. A server 504 is capable of communications with one or more communication network(s) 502 over network connection 520. For example, communication network(s) 502 may include an Internet Protocol (IP) network, cellular communications network, public switched telephone network, IEEE 802.11 wireless network, or any combination thereof. Network connection 503 may be either wired or wireless network connections. Server 504 can be a server on the local network, or a virtual server in the cloud.

Head-worn device 2 is capable of communications with electronic device 4 over a wireless link 505. In operation, user interface action data 506 from head-worn device 2 is sent to electronic device 4.

In one implementation, an application 508 executing on electronic device 4 collects user interface action data 506 and transmits it to an application 510 executing on server 504, which processes and responsively acts upon the data 506. For example, the user action data 506 may be user interface actions typically performed by a touch interface or mouse interface such as select, highlight, move, etc. In one example, application 508 is a web browser and application 510 is a website. The website may responsively transmit data corresponding to the user selection or other user action to be displayed on electronic device 4 or output at the speaker at head-worn device 2. Referring again to FIG. 4, in one example the user action is to select a coordinate on virtual coordinate system frame 410 overlaid on image 400. The image 400 is associated with data on electronic device 4 or server 504. The application executing on electronic device 4 or server 504 maps the user selected coordinate to this corresponding data to identify the user selection. In one implementation, electronic device 4 operates as a relay, and any electronic device that subscribes to the electronic device 4 can receive all user interface action data 506. In one example, an application running on electronic device 4 receives the data 506 and converts it into touchpad type user interface actions.

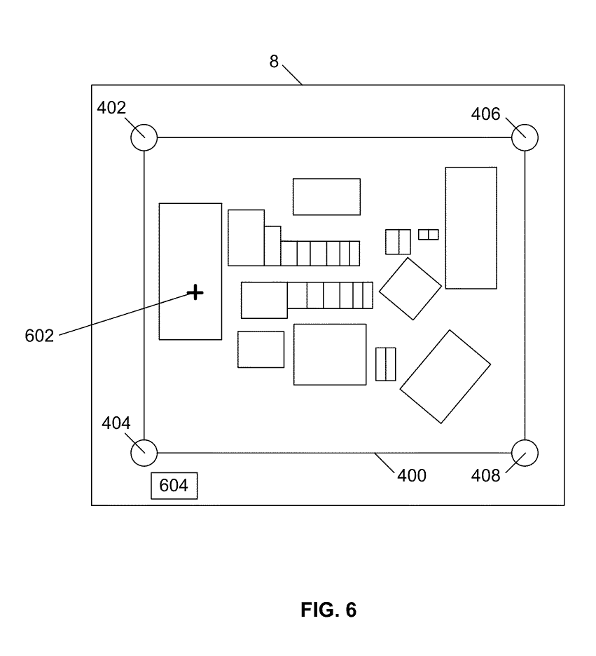

FIG. 6 illustrates an example implementation of the four point touch calibration shown in FIG. 4 and implementation 500 shown in FIG. 5. In the example shown in FIG. 6, image 400 is a non-electronic (i.e., passive) display of a map of a shopping mall or city area. Application 510 is a web site residing on server 504 containing an electronic version of the image 400 stored in memory, where coordinate locations on the image 400 have been mapped to the electronic version. In operation, the user may select a location 602 on the map image 400 as described herein. The corresponding coordinates are sent to application 510, which identifies the selected location based on the received coordinates and responsively sends data associated with location 602 to electronic device 4 and/or head-worn device 2 via network(s) 502. For example, the website may send the user directions on how to walk to location 602, the distance of location 602, the time to walk to location 602 based on the user's walking pace, stride distance, current location, and direction they are facing, or information about a store located at location 602. In one example, an electronic device 604 fixed at object 8 transmits the address of the website to electronic device 4 when the electronic device 4 is brought in proximity to object 8 using short range wireless communications (e.g., near field communications). In a further example, electronic device 4 downloads the electronic version of the image 400, so that the user interacts with electronic device 4 only, whereby an application at electronic device 4 performs the described operations instead of the website at server 504.

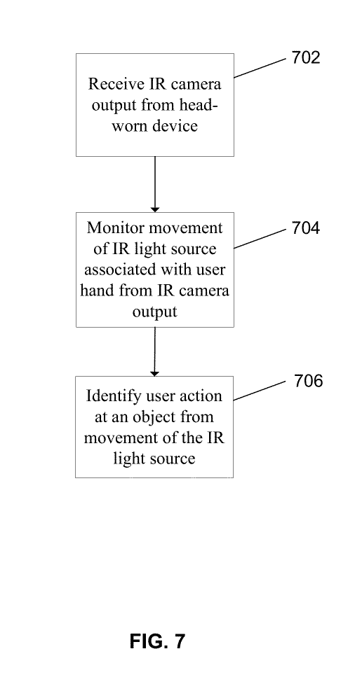

FIG. 7 is flow diagram illustrating operation of an infrared based mobile user interface. At block 702, an infrared camera output is received from an infrared camera disposed at a head-worn device. In one example, the operations further include outputting an infrared light from an infrared light source disposed at the head-worn device, the infrared light detected by the infrared camera.

At block 704, a movement of an infrared light source associated with a user hand is monitored from the infrared camera output. In one example, the operations further include receiving a sensor unit output from a sensor unit configured to detect motion of a user head, where monitoring the movement of an infrared light source associated with a user hand further includes processing the sensor unit output.

At block 706, a user action is identified at an object remote from the head-worn device from the movement of the infrared light source. In one example, the user action at an object remote from the head-worn device is a user input selection at a planar surface. In one example, the object is a planar surface and the user action comprises defining a virtual coordinate system on the planar surface. The user action further includes selecting a coordinate location within the virtual coordinate system. In one example, defining a virtual coordinate system on the planar surface includes touching four points on the planar surface to define a rectangle.

In one example, the operations further include initiating an operation at a computer responsive to the user action. In one example, the operations further include initiating an operation at the head-worn device responsive to the user action.

Example Usage Scenario

In this usage scenario, the user 1 interacts with a passive map, such as at a shopping mall showing a layout of department stores (such as image 400 shown in FIG. 6). In this example, electronic device 4 is a mobile phone. The user 1 approaches the map showing stores and service locations mounted on a large poster. As described in further detail below, operations are performed to (1) retrieve a URL, (2) retrieve the map, (3) calibrate the user fingers, and (4) gesture on the map for user interface.

The user 1 retrieves the map's URL (which has an associated server that delivers the map contents including, but not limited to, names and coordinates of user interface items). This can be done in several ways. This implementation assumes a head-worn device 2 application is utilized, which communicates with a mobile phone application, which in turn has connectivity to the Internet.

In one example, the map has a passive NFC tag. The user 1 taps their head-worn device 2 (or mobile phone or some other device) to the map and an NFC tag reader within the device could retrieve the URL. In a further example, the map has a QR code printed on it. The user 1 scans with their mobile phone or some other device with a QR code reader to retrieve the URL and initiate the head-worn device 2 application if it is not already running. In yet another example, the map has a Bluetooth Low Energy (BLE) beacon, broadcasting its URL. The head-worn device 2 (or mobile phone or some other device with a BLE reader) retrieves the URL automatically or on demand.

The head-worn device 2 communicates the URL over its data channel to the mobile phone application, initiating the application if it is not already running. The mobile phone application then uses its browsing capabilities and retrieves the map contents from the server.

The user 1 is instructed in audio from the mobile phone application to gesture at the four corners of the map. It is not necessary that the user 1 actually touch the map, only that they are roughly consistent with the distance of the finger from the head when calibrating and using the interface.

After each gesture is accepted, the user 1 is instructed to move to the next corner. Then the coordinates measured by the IR camera are mapped to the four corners of the map (for example the head-worn device 2 sends the raw coordinate retrieved to the mobile phone for processing). After this mapping is complete, future finger positions can mapped to items on the map downloaded from the server.

The user 1 then uses the map as desired. For example, the user 1 gestures on a store to get directions, gestures on the store to get the store hours, or the user gestures on the store to get an electronic discount coupon. There can also be pictures of buttons on the map. The user 1 can touch a button picture that says directions, and then the user 1 can touch each store to get the information desired.

When the user 1 gestures at an item on the map, the coordinate and associated gesture is sent to the mobile phone and translated to the map's coordinate system. This coordinate along with the desired command associated with the gesture are sent to the URL server from the mobile phone to retrieve the desired information. The URL can do any action designed for in response to a selection. For example, it can send an audio wave file to be played on the head-worn device 2 directly or through the mobile audio system (or textual data can be sent that can be converted into a wave file on the head-worn device 2 or mobile phone), providing the user 1 with the desired information.

The user 1 can indicate a selection or calibration point using a gesture. In this embodiment, the gesture recognition and coordinate retrieval are done by the head-worn device 2, and then sent to the mobile application. One way to gesture is to linger on the corner for a few seconds. If the finger has not moved for several seconds, it is considered a selection or calibration point. Another way could be a special motion, like making an “X” motion, or a small circle.

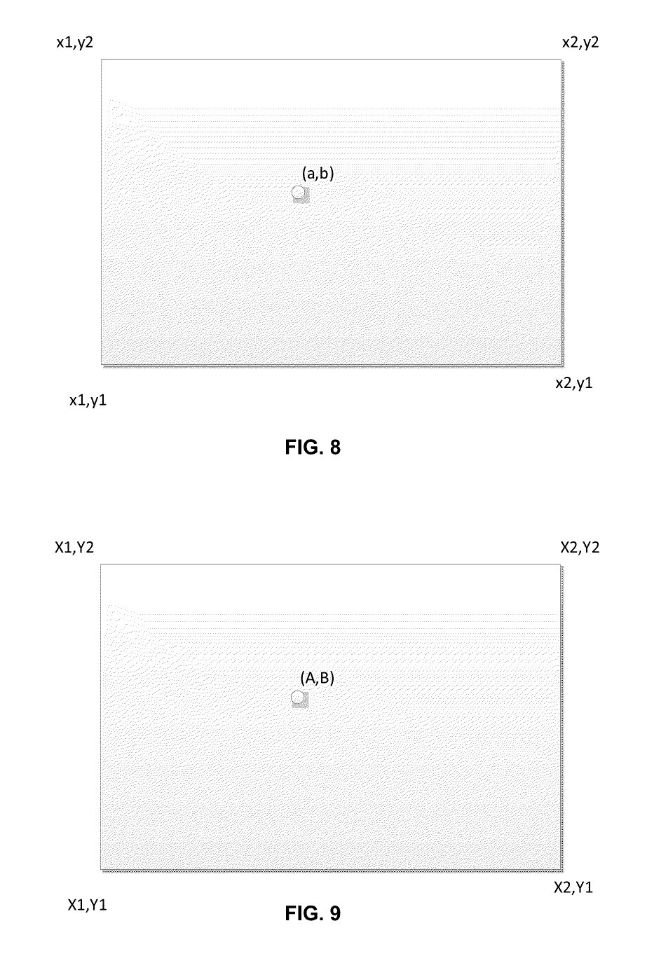

The image processing on the head-worn device 2 returns the x-y coordinate of each IR blob tracked. Assuming a single finger is used, there is only one blob. If the four points retrieved during the calibration process (where user 1 touches corners of map) have the values (x1,y1), (x2,y1), (x2,y2), (x1,y2) and the map has corresponding values in its coordinate system of (X1,Y1), (X2,Y1), (X2,Y2), (X1,Y2), the mapping process from the headset image coordinate system (retrieved from the image processing system on the head-worn device 2) to the map's coordinate system (used to determine responses) is as follows for any point (a,b) in the head-worn device 2 image system:

$$( a , b ) -> ( A , B ) = ( \begin{matrix}( \frac{( a - x 1 ) * ( X 2 - X 1 )}{( x 2 - x 1 )} ) + X 1 , \\ ( \frac{( b - y 1 ) * ( ( Y 2 - Y 1 )}{y 2 - y 1} ) + Y 1\end{matrix} ) ,$$

where the coordinates in small letters represent the head-worn device 2 coordinate system and the capital letters represent the map coordinate system. FIG. 8 illustrates a head-worn device 2 image coordinate system and FIG. 9 illustrates a map coordinate system.

While the exemplary embodiments of the present invention are described and illustrated herein, it will be appreciated that they are merely illustrative and that modifications can be made to these embodiments without departing from the spirit and scope of the invention. For example, methods, techniques, and apparatuses described as applying to one embodiment or example may also be utilized with other embodiments or examples described herein. Thus, the scope of the invention is intended to be defined only in terms of the following claims as may be amended, with each claim being expressly incorporated into this Description of Specific Embodiments as an embodiment of the invention.

What is claimed is:

1. A head-worn apparatus comprising:
a processor;
a wireless communications transceiver;
an infrared camera configured to detect an infrared light associated with a movement of a user hand and provide an infrared camera output;
a sensor unit configured to detect motion of a user head and provide a sensor unit output; and
a memory storing an application configured to receive the infrared camera output and the sensor unit output to identify a user action from the movement of the user hand.

2. The head-worn apparatus of claim 1, further comprising an infrared light source.

3. The head-worn apparatus of claim 2, wherein the infrared light associated with the movement of the user hand detected by the infrared camera comprises a reflected infrared light from the infrared light source.

4. The head-worn apparatus of claim 1, further comprising a microphone and a speaker, wherein responsive to the user action the application provides an audio output at the speaker.

5. The head-worn apparatus of claim 1, wherein the user action is a user input action at a surface remote from the head-worn apparatus.

6. The head-worn apparatus of claim 1, wherein the user action is a user selection of a coordinate location on a coordinate system virtually overlaid on a surface remote from the head-worn apparatus.

7. One or more non-transitory computer-readable storage media having computer-executable instructions stored thereon which, when executed by one or more computers, cause the one more computers to perform operations comprising:
receiving an infrared camera output from an infrared camera disposed at a head-worn apparatus;
monitoring a movement of an infrared light source associated with a user hand from the infrared camera output; and
identifying a user action at an object remote from the head-worn apparatus from the movement of the infrared light source.

8. The one or more non-transitory computer-readable storage media of claim 7, wherein the operations further comprise: receiving a sensor unit output from a sensor unit configured to detect motion of a user head, wherein monitoring the movement of an infrared light source associated with a user hand further comprises processing the sensor unit output.

9. The one or more non-transitory computer-readable storage media of claim 7, wherein the operations further comprise outputting an infrared light from an infrared light source disposed at the head-worn apparatus, the infrared light detected by the infrared camera.

10. The one or more non-transitory computer-readable storage media of claim 7, wherein the user action at an object remote from the head-worn apparatus is a user input selection at a planar surface.

11. The one or more non-transitory computer-readable storage media of claim 7, wherein the operations further comprise: initiating an operation at a computer responsive to the user action.

12. The one or more non-transitory computer-readable storage media of claim 7, wherein the operations further comprise: initiating an operation at the head-worn apparatus responsive to the user action.

13. The one or more non-transitory computer-readable storage media of claim 7, wherein the object is a planar surface and the user action comprises defining a virtual coordinate system on the planar surface.

14. The one or more non-transitory computer-readable storage media of claim 13, wherein the user action further comprises selecting a coordinate location within the virtual coordinate system.

15. The one or more non-transitory computer-readable storage media of claim 13, wherein defining a virtual coordinate system on the planar surface comprises touching four points on the planar surface to define a rectangle.

16. A system comprising:
one or more computers; and
one or more non-transitory computer-readable storage media having computer-executable instructions stored thereon which, when executed by the one or more computers, cause the one or more computers to perform operations comprising:
receiving an infrared camera output from an infrared camera disposed at a head-worn apparatus;
monitoring a movement of an infrared light source associated with a user hand from the infrared camera output; and
identifying a user action at an object remote from the head-worn apparatus from the movement of the infrared light source.

17. The system of claim 16, wherein the operations further comprise: receiving a sensor unit output from a sensor unit configured to detect motion of a user head, wherein monitoring the movement of an infrared light source associated with a user hand further comprises processing the sensor unit output.

18. The system of claim 16, wherein the operations further comprise: outputting an infrared light from an infrared light source disposed at the head-worn apparatus, the infrared light detected by the infrared camera.

19. The system of claim 16, wherein the user action at an object remote from the head-worn apparatus is a user input selection at a planar surface.

20. The system of claim 16, wherein the operations further comprise: initiating an operation at a computer responsive to the user action.

21. The system of claim 16, wherein the operations further comprise: initiating an operation at the head-worn apparatus responsive to the user action.

22. The system of claim 16, wherein the object is a planar surface and the user action comprises defining a virtual coordinate system on the planar surface.

23. The system of claim 22, wherein the user action further comprises selecting a coordinate location within the virtual coordinate system.

24. The system of claim 22, wherein defining a virtual coordinate system on the planar surface comprises touching four points on the planar surface to define a rectangle.
